(19) United States
(12) Patent Application Publication
(10) Pub. No.: US 2012/0320087 A1
(43) Pub. Date: Dec. 20, 2012

(54) System and Methods for Parallelizing Polygon Overlay Computation in Multiprocessing Environment

(75) Inventor: Xuan Shi, Atlanta, GA (US)

(73) Assignee: GEORGIA TECH RESEARCH CORPORATION, Atlanta, GA (US)

(21) Appl. No.: 13/523,196

(22) Filed: Jun. 14, 2012

Related U.S. Application Data
(60) Provisional application No. 61/496,665, filed on Jun. 14, 2011.

(51) Int. Cl. G09G 5/00

(52) U.S. Cl. 345/629

(57) ABSTRACT

In a system for parallelizing polygon overlay operations, a potential for intersection between polygons is determined by the bounding box of each polygon on a base layer in relation to the bounding box of each polygon on an overlay layer. The potential for intersection exists when a vertex of a bounding box around an overlay layer feature is within a bounding box around a base layer feature and vice versa. Calculations to determine the presence of vertices within bounding blocks are performed in parallel on multiple processors. Polygon overlay operations are performed only between features that have a potential to intersect.

### CROSS-REFERENCE TO RELATED APPLICATION(S)

This application claims the benefit of U.S. Provisional Patent Application Ser. No. 61/496,665, filed Jun. 4, 2011, the entirety of which is hereby incorporated herein by reference.

### STATEMENT OF GOVERNMENT INTEREST

This invention was made with government support under grant No. CCF-1048162, awarded by the National Science Foundation. The government has certain rights in the invention.

### BACKGROUND OF THE INVENTION

1. Field of the Invention

The present invention relates to systems for geometric computations and, more specifically, a system for parallelizing vector polygon overlay computation in any computing environment that has multiple processors and cores, including but not limited to grid and cloud computing system, Graphic Processing Unit (GPU), and hybrid systems that have multiple Central Processing Units (CPUs) and GPUs.

2. Description of the Related Art

Geographic information systems (GIS) capture and present geographic information in a digital format. For example the features on a map (e.g., rivers, parks, buildings, roads, etc.) can be described in a digital format so that spatial relationships between such features can be analyzed through geospatial operations. There are many different uses for GIS, such as for city planning and administration, environmental modeling and analytics, transportation and logistics, civil and military services.

One type of GIS plots data in a rasterized format. In such a system, geographic features are modeled in a raster grid format. . Computations involving features is done on a cell-by-cell or pixel-by-pixel basis. Because of the pixelated nature of the features, computations involving many different features can be computationally complex.

Another type of GIS, as shown in FIG. 1, employs vector geometry to represent descriptions of features as point, line, and polygon, while polygon is the most complex geometric type. In such a system a polygon feature 10 has a series of vertexes 12, starting from a unique point , which is also the ending point, are projected around the feature 10. If the feature is a line, the starting point may not be the same as the ending point. .

Typical GIS systems, as shown in FIG. 2, capture and store features onto different layers. For example, in a map of a rural area, one layer might include all of the corn fields in a region, another layer might include all of the soybean fields in the region, another layer might include all of the lakes in the region, and yet another layer might include all of the roads in the region. Typically, the user of a GIS system designates a layer with a first type feature 22 as a base layer 20 and designates subsequent layers with subsequent feature types 26 as overlay layers 24. The user then uses the GIS system to find relationships between the features of different layers by projecting a feature 26′ from the overlay layer 24 onto the base layer 20 and calculating the spatial relationships through either Boolean operations or topological operations between the projected feature 26′ and the base layer feature 22.

As shown in FIG. 3A, Boolean operations render a “true” or “false” result, indicating whether a given relationship exists between two features. The Boolean operations used in many GIS systems include: equal, disjoint 38, intersects, touch 30 & 32, overlap 36, cross, within, contains 34. As shown in FIG. 3B, topological operations result in the generation of new features based on the relationships between two layers 40 (such as features from layer “A” and layer “B”). Such topological operations include difference (A-B) 42, difference (B-A) 44, A intersect B 46 (which is the same as B intersect A), A XOR B 48, and A union B 50. XOR means Exclusive OR/Symmetric difference. As can be seen in FIG. 3C, some topological operations can be achieved by combining other operations. For example, A union B is the same as a combination of A intersect B 46, B intersect A 46 and A XOR B 48, which is a combination of A difference of B plus B difference of A.

Users of GIS systems often use the data presented therein in making decisions. For example, as shown in FIGS. 4A a map 50 of an area might include a highway 52, a river 54 and a plurality of houses 56. As shown in FIG. 4B, a 100 year flood plain 58 around the river can be plotted on the map and, as shown in FIG. 4C, represented as a first polygon 60. Similarly, as shown in FIG. 4D, a constant distance 62 (e.g., five miles) from the highway can be plotted on the map and represented as a second polygon 64, as shown in FIG. 4E. A user might be interested in finding a house that is within five miles of the highway and outside of the 100 year floodplain of the river. To find such a region, the GIS system will overlay the first polygon 60 and the second polygon 64, as shown in FIG. 4F, and determine which regions of the two polygons intersect, thereby generating new regions 66 of intersection. This data can then be overlaid onto the map with the houses, as shown in FIG. 4G, thereby demonstrating which houses 68 meet the user's criteria.

Polygon overlay operations can be computationally intensive, especially when there are many polygons on each level. For example, calculating interrelationships between layers that both contain over 500,000 features can overtax even the fastest computers. Polygon overlay computation has been identified as a killer application in parallel computing. Few prior works can accomplish such a task in an efficient way according to the prior arts in this front.

There is a need for a system that performs overlay calculations the makes use of multiprocessor parallel systems.

### SUMMARY OF THE INVENTION

The disadvantages of the prior art are overcome by the present invention which, in one aspect, is a method, scalable and operable on a multiprocessor parallel computer system that includes a plurality of processors (in CPUs or GPUs) in data communication with a tangible computer readable memory, for computing overlay between a first plurality of polygons on a base layer and a second plurality of polygons on an overlay layer. Each of the polygons is defined by a plurality of segments in a Cartesian coordinate system. In the method a bounding box is defined as the spatial extent of each polygon so that each bounding box includes four vertices disposed at the following points in the Cartesian coordinate system, including the minimum x value, minimum y value, maximum x value, and maximum y value of the bounding box. Through parallel sorting of the x values and y values of the bounding boxes for polygon features, each polygon in the base layer establishes 0 or 1 to many relationship to those polygon features within the overlay layer. A linkage table stores such relationships, indicating that each polygon in the base layer may or may not have the potential to intersect polygon features in the overlay layer. . Spatial overlay operations are performed only between polygons in the base layer that have the potential to intersect polygons in the overlay layer.

In another aspect, the invention is a computer system for computing polygon overlay that includes a plurality of processors, a tangible computer readable memory in data communication with the plurality of processors and a program stored on the computer readable memory that is configured to compute overlay between a first plurality of polygons on a base layer and a second plurality of polygons on an overlay layer according to the method disclosed above.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic representation of a polygon that represents a feature in a vector graphics system.

FIG. 2 is a schematic representation of two layers with features represented thereon.

FIG. 3A is a schematic representation of several Boolean operations.

FIG. 3B is a schematic representation of results of several topologic operations.

FIG. 3C is a schematic representation a topologic operation being performed based on the results of other topologic operations.

FIG. 4A is a representation of a map.

FIG. 4B is a representation of a first feature relating to the map shown in FIG. 4A.

FIG. 4C is a representation of a first polygon representing the feature shown in FIG. 4B.

FIG. 4D is a representation of a second feature relating to the map shown in FIG. 4A.

FIG. 4E is a representation of a second polygon representing the feature shown in FIG. 4D.

FIG. 4F is a representation of a the results of a topological operation performed on the first polygon overlaid on the second polygon.

FIG. 4G is a representation of a the results of the topological operation demonstrated in FIG. 4F projected onto the map shown in FIG. 4A

FIG. 5 is a schematic diagram of a parallel computer network employed in one representative embodiment.

FIG. 6 is a diagram showing a method of determining if overlaid features have a potential for intersecting.

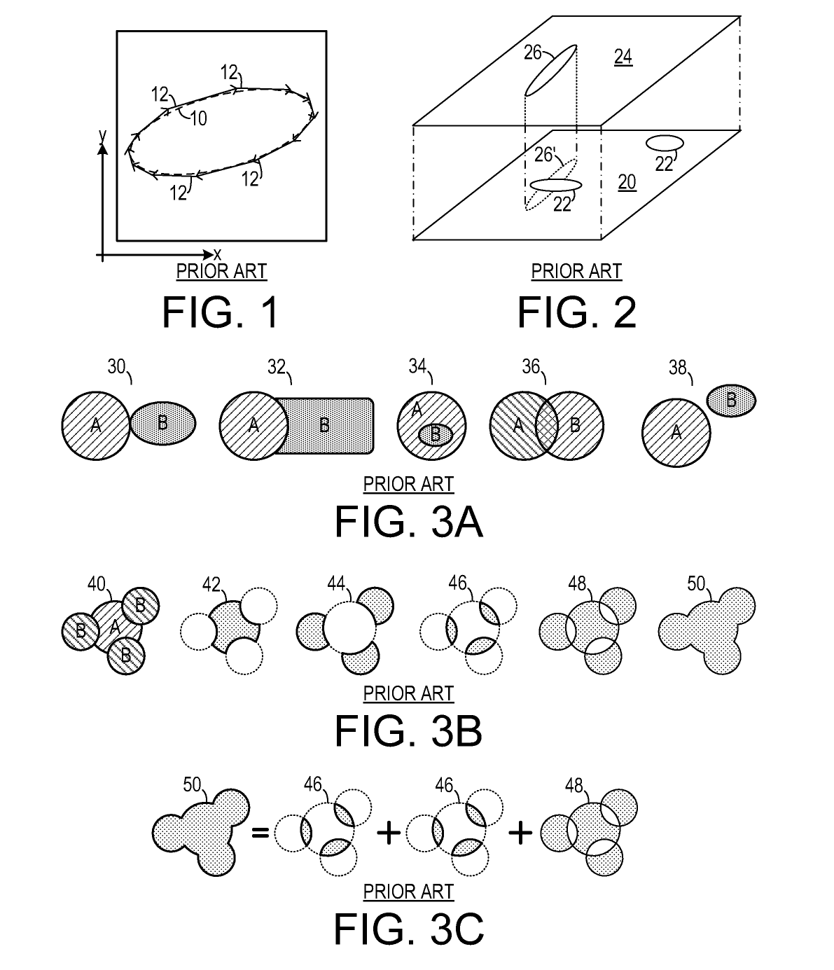

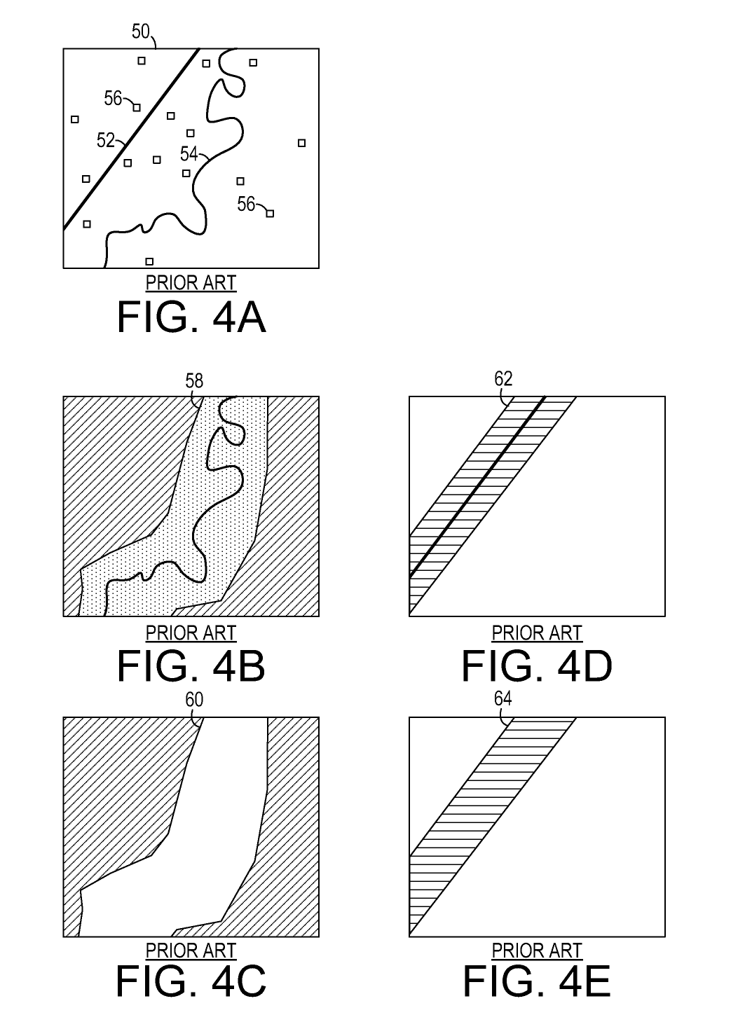

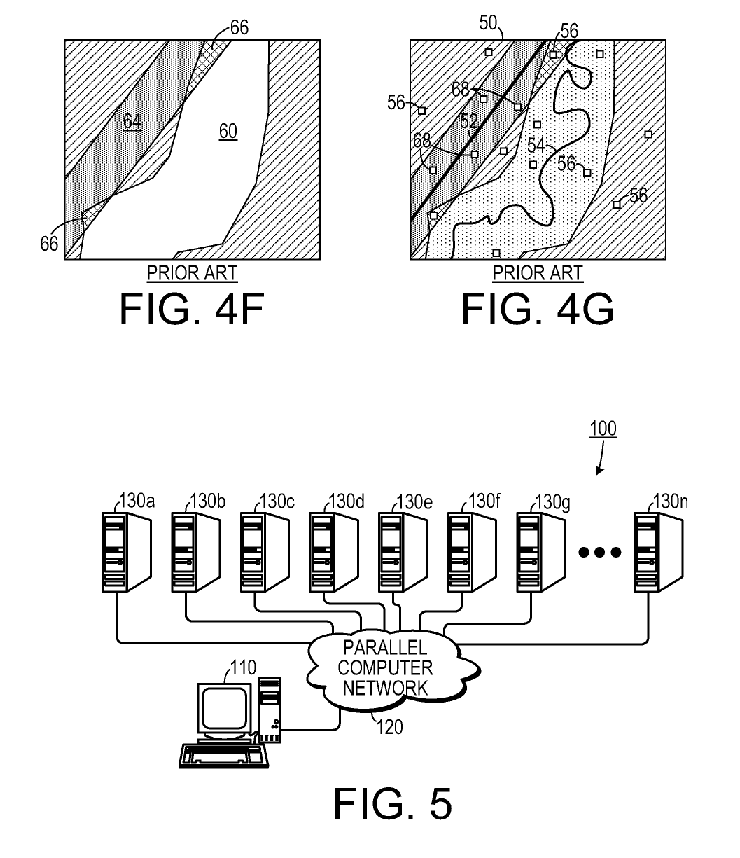

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

As shown in FIG. 5, one representative embodiment employs a parallel computer system 100 to perform polygon overlay operations. The system 100 may include at least one work station 110 that is coupled to a parallel computer network 120, which is coupled to a plurality of parallel processors 130a-n. While the parallel processors 130a-n are shown in the example as stand-alone computers, they could include individual processor chips on a single circuit board or even different processor units within a single integrated circuit and could include central processing units (CPUs), graphics processing units (GPUs), or any other type of processing unit capable of operating in a multiprocessing environment. The parallel computer network 120 could include a local network, a network on a single board, a global computer network, or any computer network that is capable of administering communications in a parallel computing system. As will be appreciated by those of skill in the computing arts, the parallel computing network 120 can include one of many types of multiprocessing environments, which can include multiple CPU-based parallel processors, a single Graphic Processing Unit (GPU), GPU clusters, and hybrid systems that have multiple CPUs and GPUs. Grid computing systems and cloud computing systems may also be part of the parallel computing network 120.

The system uses the parallel computer system 100 to determine quickly which polygons that are overlaid onto a base layer from an overlay layer have a potential of intersecting each other through a parallel sorting algorithm to process the bounding boxes of each features in both base layer and overlay layer. A linkage table is created as the result of parallel sorting. Following the linkage table, the system does not perform any topological operations on polygons in the base layer that do not have a potential of intersecting any other polygon in the overlay layer because such operations would always give a null result. Therefore, the system could save substantial amounts of computational time by performing topological operations only on those polygons that have a potential of giving a meaningful result.

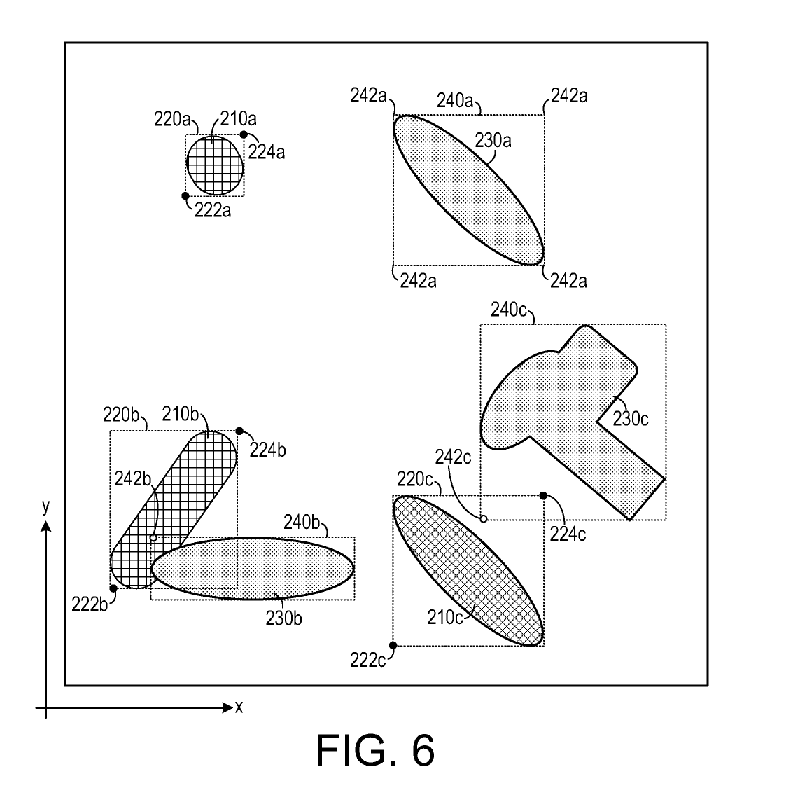

As shown in FIG. 6, to determine if polygons have a potential for intersecting each other, the system examines bounding boxes 220x around each polygon 210x on the base layer and bounding boxes 240x around each polygon 230x in the overlay layer (wherein in the example shown, the letter “x” is a placeholder for a letter denoting a specific polygon). For example, the system examines the bounding box 220a around polygon 210a in the base layer. The bounding box is a rectangle defined by the minimum x and y coordinate of vertex 222x and the maximum x and y coordinate of vertex 224x. The system compares the vertices 242x of each bounding box 240x of each polygon 230x in the overlay layer to determine if at least one of the vertices 242x of a bounding box 240x are within the bounding box 220x of each of the features 210x in the boundary layer.

In one embodiment, the system creates a linkage table that compares each feature in the base layer to each feature in the overlay layer and determines in each comparison if there is a potential for the two features to intersect. For any selected base layer feature compared to any selected overlay layer feature, a potential for intersection exists when the following condition is met for any vertex in the overlay layer feature: the minimum x or y coordinate or maximum x or y coordinate of the bounding box of a feature in the base layer is between the minimum x or y coordinate or maximum x or y coordinate of the bounding box of a feature in the overlay layer, and vice versa. Since each one of these comparisons is independent of each other, the determination of the potential of intersection can be performed in a massively parallel computer system.

This process is demonstrated by several examples in FIG. 6. In the first example, none of vertices 242a of the bounding box 240 of overlay layer feature 230a are within the bounding box 220a of base layer feature 210a, or any of the other base layer bounding boxes. Therefore, there is no potential for intersection and, thus, no topological operations would be performed on feature 230a.

On the other hand, vertex 242b is within bounding box 220b and, therefore, there is a potential for intersection between feature 210b and feature 230b. In this case, overlay operations would be performed between the two features.

Vertex 242c lies within bounding box 220c and therefore, the system determines that there is a potential that feature 210c intersects feature 230c, even though they actually do not intersect. In this case, the system would perform overlay operations on these two features, even though such operations would generate a null result.

To facilitate parallel computation, one embodiment employs 1) a renovated data structure that is designed for parallel computing; and 2) a methodology for parallelizing polygon overlay computation in a multiprocessing environment. The renovated polygon data structure is different from the traditional one designed for desktop and standalone Geographic Information System (GIS), such as Shapefile or Geographic Markup Language (GML) which were not designed for parallel computing. To enable fast data parsing and partitioning on at least two input feature classes or layers, the proposed polygon data structure can be applied in both binary (e.g. Shapefile or Geodatabase) and XML (e.g. GML) formats. The renovated data structure will cover the following properties:

1. For each feature class (layer), the following information must be exposed:

(a) a unique name of the feature class;

(b) the spatial extent (minX, minY, maxX, maxY) of the feature class (layer);

(c) projection and datum of the coordinate system;

(d) the number of features; and

(e) a Boolean variable (true or false) about whether any feature is overlapped with the other(s).

2. For each feature in the feature class (layer), the following information must be exposed:

(a) a unique identifier of the feature;

(b) the spatial extent (minx, minY, maxX, maxY) of the feature;

(c) the number of exterior ring(s);

(d) other features (by the unique identifier(s)) that are overlapped with this feature; and

(e) attribute fields, though this information is not relevant to overlay computation.

3. For each exterior ring in a feature, the following information must be exposed:

(a) the unique identifier of the feature;

(b) a unique identifier of the exterior ring;

(c) the number of interior rings within this exterior ring;

(d) the number of vertexes of this exterior ring; and

(e) the x, y coordinates of the vertexes of the exterior ring.

4. For each interior ring in an exterior ring, the following information must be exposed:

(a) the unique identifier of the feature;

(b) the unique identifier of the exterior ring;

(c) a unique identifier of the interior ring;

(d) the number of vertexes of the interior ring; and

(e) the x, y coordinates of the vertexes of the interior ring.

The output product has the same data structure described above in paragraph [0039] above, while the output feature table contains information from both feature tables, such as the unique feature identifiers and attributes from both base layer and overlay layer. The proposed data structure can be used in GIS software engineering and geospatial database management system (DBMS), which means parallelized GIS software and DBMS should provide corresponding classes, objects, and functional APIs in order to efficiently access the data structure described above without the need to loop through all polygon features in a feature class (layer) to derive the critical information used.

In the method for parallelizing polygon overlay computation in multiprocessing environment, the key is how to use multiprocessing resources (multiple CPU cores or GPU cores) to implement any overlay computation algorithm that was designed for a desktop and standalone GIS. For this reason, algorithm is not the key in this solution. If the base layer or overlay layer has overlapped features, the first step in the parallelized overlay computation process is to execute the intersect operation on the overlapped features in both base layer and overlay. The output will be used in the following implementation procedures, newly intersected features will be documented and inserted into the base layer and overlay layer, while the old features will not be used in the following partitioning and calculation processes. This step is required ONLY in the cases of “intersect,” “union,” “XOR,” and “difference”. However, it is not required in the cases of Boolean operations like “equal,” “within,” “contain,” “touch,” and “disjoint.”

Data partitioning is the key step in this parallelization process. In polygon overlay computation, input feature classes or layers are normally referred as base layer and overlay layer. The criterion of data partition is based on the potential spatial relationship between features in the base layer and overlay layer. If feature(s) have potential spatial relationship, they will be assigned to the computing nodes (CPU cores or GPU cores) to determine the true spatial relationship between them by a certain algorithm of spatial overlay operation otherwise they have no spatial relationship. The linkage table is based on the spatial extent (minx, minY, maxX, maxY) of a feature by parallel sorting of the spatial extent or by parsing spatial indexes. Within this linkage table, features have the potential spatial relationship because their spatial extents are intersected. As a result, each feature in the base layer will be linked to zero (0), one (1) or many feature(s) in the overlay layer. Although many overlay computations only identify or generate new features only from the base layer, such as operators of “equal,” “within,” “contain,” “touch,” “intersect,” a few operators will generate the output relevant to both base layer and overlay layer, such as “union,” “XOR” and “difference.” In this case, a linkage table should be created for the overlay layer. As a result, each feature in the overlay layer will be linked to zero (0), one (1) or many feature(s) in the base layer.

Implementing overlay computation algorithms on the computing nodes (CPU cores or GPU cores) in parallel based on the linkage table(s). The traditional approaches need to split features first and merge the output based on the quad tree or uniform grid approach for data partitioning in the cases of “intersect,” “union,” and “difference.” The sequential processes of splitting and merging features significantly increase the overhead time in data parsing. The claimed solution does NOT need to split and merge features at all. Since the features from base layer and overlay layer that have the potential spatial relationship are linked, implementing overlay computation algorithms in parallel is feasible and efficient. Each computing node will first select the geometry of the feature in base layer (exterior and interior rings) by its unique identifier. Based on the linkage table, the geometry of the linked feature(s) in the overlay layer (exterior and interior rings) are selected by the unique feature identifier(s).

The overlay operations are performed to generate the output. This procedure is identical to the Boolean operations to determine whether a feature in the base layer “equals,” is “within,” “contains,” “intersects” or “touches” a feature in the overlay layer. In the case of topological operations of “intersect,” “difference,” “union” and “XOR,” the linkage table will be created differently to implement these topological operations. In the cases of difference, union and XOR, both linkage tables will be used to implement the corresponding operations. In the case of intersect, only one linkage table will be created since the result of A intersect of B is the same as the result of B intersect of A. The results of the topological overlay operations will include segments of intersected polygons (intersected is true and marked as T, which is the output of the “intersect” operation) and segments or non-intersected polygons (intersected is false and marked as F, which is the output of the “difference” operation). Through one operation, the result will be marked up with T or F in two parts. The result of overlay then can be combined according to the input requirement. If intersect is the required operation, then the output will be the integration of ALL segments marked as T. If difference is the required operation, then the output will be the integration of ALL segments marked as F. If Union is the required operation, then the output will be the integration of ALL segments marked as T [integrated twice] plus ALL segments marked as F according to two linkage tables. If XOR is the required operation, then the output will be the integration of ALL segments marked as F according to two linkage tables. The optimized solution need not run four operations to derive the result for Union, but instead, it performs two operations as mentioned above.

The final output will be organized as the follows: In the cases of intersect, all segments marked as T from the base layer only will be used to generate the output; In the cases of difference, all segments marked as F from the base layer only will be used to generate the output; In the cases of union, all segments marked as T and F from the base layer an d those segments marked as F from the overlay layer will be used to generate the output; In the cases of XOR, all segments marked as F from both of the base layer and the overlay layer will be used to generate the output. The output generated from each computing node is stored into the final product, which can be in different format, such as a binary file, Geodatabase, and XML document.

Regarding I/O Strategies in multicore and many-core environment, in the case of GPU, data reading and writing may have to be implemented on CPU cores which are used to complete the processes of data partitioning and aggregation of output from the GPU cores, while spatial overlay computation can be implemented over GPU cores. The same strategy can be applied in Cloud and grid computing. Given the example of Azure cloud platform, data reading and writing can be implemented by the Web roles which are used to complete the processes of data partitioning and aggregation of output from the Worker roles, while spatial overlay computation can be implemented over the Worker roles. Grid computing with MPI shares the same strategy for implementation. In cloud and grid computing environments, multiple CPU cores can be utilized for computation. Therefore, I/O may not be a problem. In this case, data reading the writing can be implemented by each computing nodes (CPU cores) in parallel, not in sequential. For example, in the Azure cloud platform, the Web role can directly dispatch the job to the Worker roles. Then each worker role will directly read data from the shared global memory, implement the overlay computation, and write the output into the file system (in binary or XML format) without the need of aggregation process by the Web role as stated in above.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A parallel method for scalable vector overlay computation in multiprocessing environment that that includes a plurality of processors in data communication with a tangible computer readable memory, operable on a selected one of a CPU, a GPU, or a hybrid computer system, for computing overlay relations between a first plurality of polygons on a base layer and a second plurality of polygons on an overlay layer, each of the polygons defined by a plurality of segments in a Cartesian coordinate system, the method comprising the steps of:
(a) examining bounding box around each polygon so that each bounding box is defined by a spatial extent in the Cartesian coordinate system as a minimum x coordinate, a minimum y coordinate, a maximum x coordinate and a maximum y coordinate;
(b) through a parallel sorting computation implemented over the plurality of processors in parallel, determining for each bounding box of each polygon feature in the base layer whether and how many bounding boxes of polygon features in the overlay layer are intersected, thereby generating a linkage table that lists polygon features in the base layer that have a potential spatial relationship with polygon features in the overlay layer;
(c) performing geometric overlay operations only between polygons in the overlay layer that have the potential to intersect polygons in the base layer.

2. The method of claim 1, wherein the polygons represent geometric features in a selected coordinate system.

3. The method of claim 1, wherein the step of performing geometric overlay operations comprises the step of performing at least one topological operation selected from a list consisting of: intersect, difference, union and XOR.

4. The method of claim 3, wherein the step of performing a topological operation generates a new feature corresponding to the topological operation.

5. The method of claim 4, wherein if a first polygon A is being overlaid a second polygon B, then performing at least a selected one of the following overlay fundamental operations: difference(A-B); difference(B-A), intersect (A-B) or intersect (B-A).

6. The method of claim 5, where the XOR topological operation is performed by combining the results of the difference (A-B) operation and the difference (B-A) operation.

7. The method of claim 6, where the union topological operation is performed by combining the results of XOR operation, the intersect (A-B) operation and intersect (B-A) operation.

8. The method of claim 1, wherein the step of performing geometric overlay operations comprises the step of performing a Boolean operation selected from a list consisting of:
touch single point, touch multiple points, contain, intersect and disjoint.

9. A computer system for computing polygon overlay, comprising:
(a) a plurality of parallel processors;
(b) a tangible computer readable memory in data communication with the plurality of parallel processors;
(c) a program stored on the computer readable memory that is configured to compute overlay between a first plurality of polygons on a base layer and a second plurality of polygons on an overlay layer, each of the polygons defined by a plurality of segments in a Cartesian coordinate system, the program configured to instruct at least a set of the plurality of processors to execute the following operations:
(i) project a bounding box around each polygon so that each bounding box is defined by the minimum x and y coordinate and maximum x and y coordinate in the Cartesian coordinate system;
(ii) perform a parallel sorting on the plurality of parallel processors for each bounding box of polygon features in the base layer and each bounding box of polygon features in the overlay layer to determine which polygon features in the overlay layer have a potential spatial relationship with each polygon feature in the base layer, in which the potential spatial relationship exists when a bounding box of a feature in the base layer intersects with a bounding box of a polygon feature in the overlay layer;
(iii) on at least one processor, generate a linkage table that indicates whether each bounding box in the overlay layer intersects each bounding box in the base layer, thereby indicating that the corresponding polygon in the overlay layer has a potential to intersect the corresponding polygon in the base layer; and
(iv) perform geometric overlay operations only between polygons in the overlay layer that have the potential to intersect polygons in the base layer.

10. The computer system of claim 9, wherein the polygons represent features in a selected coordinate system.

11. The computer system of claim 9, wherein the step of performing geometric overlay operations comprises the step of performing a topological operation selected from a list consisting of: intersect, difference, union and XOR.

12. The computer system of claim 11, wherein the step of performing a topological operation generates a new feature corresponding to the topological operation.

13. The computer system of claim 12, wherein if a first polygon A is being overlaid a second polygon B, then performing at least a selected one of the following overlay fundamental operations: difference(A-B); difference(B-A), intersect (A-B) or intersect (B-A).

14. The computer system of claim 13, where the XOR topological operation is performed by combining the results of the difference (A-B) operation and the difference (B-A) operation.

15. The computer system of claim 14, where the union topological operation is performed by combining the results of XOR operation, the intersect (A-B) operation and intersect (B-A) operation.

16. The computer system of claim 9, wherein the step of performing geometric overlay operations comprises the step of performing a Boolean operation selected from a list consisting of: touch single point, touch multiple points, contain, intersect and disjoint.
